(19) United States
(12) Patent Application Publication
(10) Pub. No.: US 2022/0270165 A1
(43) Pub. Date: Aug. 25, 2022

(54) AUTONOMOUS VEHICLE MANAGEMENT DEVICE

(71) Applicant: TOYOTA JIDOSHA KABUSHIKI KAISHA, Aichi-ken (JP)

(72) Inventors: Shin SAKURADA, Toyota-shi (JP); Katsuya HOSHI, Nisshin-shi (JP); Hiroaki SUGIYAMA, Nagoya-shi (JP); Masahisa SAWADA, Nagoya-shi (JP); Hiroyuki ITO, Kariya-shi (JP); Makoto SEGI, Kariya-shi (JP); Hiroki HATTORI, Kariya-shi (JP)

(21) Appl. No.: 17/676,825

(22) Filed: Feb. 22, 2022

(30) Foreign Application Priority Data
Feb. 24, 2021 (JP) 2021-027050

(51) Int. Cl. G06Q 30/06; G06Q 10/06

(52) U.S. Cl. CPC G06Q 30/0645; G06Q 10/06314; B60W 60/00253

(57) ABSTRACT

When a rental user schedule management unit (general user schedule management unit) receives, from a general user (rental user) different from the priority user that is a lease contractor, a general usage request for a predetermined autonomous vehicle in which a time zone excluding a priority usage time zone is specified, the rental user schedule management unit set the time zone specified by the general usage request as a general usage time zone.

### CROSS-REFERENCE TO RELATED APPLICATION

This application claims priority to Japanese Patent Application No. 2021-027050 filed on Feb. 24, 2021, incorporated herein by reference in its entirety.

### BACKGROUND

### Technical Field

The present specification discloses an autonomous vehicle management device.

### Description of Related Art

Conventionally, an autonomous vehicle that performs autonomous driving instead of driving by a driver has been known. For example, in Japanese Unexamined Patent Application Publication No. 2020-077385 (JP 2020-077385 A) and Japanese Unexamined Patent Application Publication No. 2016-210417 (JP 2016-210417 A), this autonomous vehicle is used as a temporary-use vehicle such as a taxi or a rental car.

### SUMMARY

By the way, as a usage form of an autonomous vehicle, using the autonomous vehicle with a lease contract can be considered. A lease contract refers a lease agreement over a relatively long-term such as one year or five years, and is distinguished from a lease agreement over a relatively short-term on an hourly or daily basis such as a rental contract.

The present specification discloses an autonomous vehicle management device capable of effectively utilizing an autonomous vehicle in a time zone in which a lease contractor does not use the vehicle (idle time zone).

The autonomous vehicle management device disclosed in the present specification includes a priority user information storage unit, a priority user schedule management unit, a general user schedule management unit, and a transmission-reception unit. The priority user information storage unit associates identification information given to a predetermined autonomous vehicle and information of a priority user who is able to use the autonomous vehicle with priority and stores the identification information and the information of the priority user. The priority user schedule management unit sets a priority usage time zone of the autonomous vehicle in accordance with a priority usage request by the priority user. The general user schedule management unit sets a time zone specified by a general usage request as a general usage time zone, when the general user schedule management unit receives, from a general user different from the priority user, the general usage request for the autonomous vehicle in which a time zone other than the priority usage time zone is specified. The transmission-reception unit transmits reservation confirmation information of the general usage time zone to the general user.

According to the above configuration, the vehicle can be used by a general user such as a rental user during a time zone when the priority user such as the lease contractor does not use the autonomous vehicle.

In the above configuration, after the reservation confirmation information is transmitted, when the general user schedule management unit receives the priority usage request in which a time zone including at least a part of the general usage time zone is specified, the general user schedule management unit may cancel a setting of the general usage time zone. In addition, the autonomous vehicle management device includes a vehicle dispatch unit. The vehicle dispatch unit performs, for the general user, a vehicle dispatch reservation of an autonomous vehicle that is able to be used in the canceled general usage time zone and that is different from the autonomous vehicle.

According to the above configuration, it is possible to ensure that the priority user uses the autonomous vehicle (priority usage), and it is possible to ensure convenience of the general user by performing a vehicle dispatch reservation of a substitute vehicle for the general user.

In the above configuration, the priority user schedule management unit may prohibit an input of the priority usage request in which a time zone including at least a part of the general usage time zone is specified, for a period from a predetermined time before a start time of the general usage time zone to the start time.

According to the above configuration, it is possible to avoid the general usage of the autonomous vehicle from being cancelled immediately before the general usage.

Further, in the above configuration, the autonomous vehicle management device may include a map creation unit. The map creation unit determines a movable range of the autonomous vehicle used by the general user in accordance with a start time of the priority usage time zone, in the general usage time zone before the start time of the priority usage time zone.

According to the above configuration, the occurrence of a situation in which the return time of the autonomous vehicle exceeds the general usage time zone and the start of the priority usage is delayed due to this is suppressed.

According to the autonomous vehicle management device disclosed in the present specification, a contracted autonomous vehicle can be effectively utilized in a time zone in which the vehicle is not used by a lease contractor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a hardware configuration diagram illustrating an autonomous vehicle management system including an autonomous vehicle management device according to the present embodiment;

FIG. 2 is a perspective view illustrating an autonomous vehicle according to the present embodiment;

FIG. 3 is a functional block diagram illustrating the autonomous vehicle management system according to the present embodiment;

FIG. 4 is a diagram illustrating an example of a lease contractor information table stored in a lease contractor information storage unit;

FIG. 5 is a diagram illustrating a rental user information table stored in a rental user information storage unit;

FIG. 6 is an image in which a lease contractor application is being executed and is a diagram illustrating a usage schedule image of the autonomous vehicle;

FIG. 7 is an image in which the lease contractor application is being executed and is a diagram showing an example when a schedule setting box is displayed;

FIG. 8 is an image in which the lease contractor application is being executed and is a diagram showing an example when editing or deleting a priority usage time zone;

FIG. 9 is a diagram illustrating a rental reservation flow of the autonomous vehicle;

FIG. 10 is an image while a rental user application is being executed and is a diagram that shows an example in which an input form of the general usage time zone is displayed;

FIG. 11 is an image while the rental user application is being executed and is diagram that shows an example in which a vehicle that can be generally used is selected (wide area selection);

FIG. 12 is an image while the rental user application is being executed and is diagram that shows an example in which the vehicle that can be generally used is selected (narrowing selection);

FIG. 13 is an image in which the rental user application is being executed and is a diagram that shows an example in which reservation confirmation information is displayed;

FIG. 14 is a diagram illustrating an example of the usage schedule in which the general usage time zone is set;

FIG. 15 is a diagram illustrating an overlapping elimination flow of usage time zones;

FIG. 16 is an image in which the lease contractor application is being executed and is a diagram showing an example in which a usage date and time are input in an input form of a priority usage time zone;

FIG. 17 is an image while the rental user application is being executed and is a diagram that shows an example in which a candidate of a substitute vehicle that can be generally used is displayed; and

FIG. 18 is an image in which the rental user application is being executed and is a diagram that shows a movable range of the autonomous vehicle.

### DETAILED DESCRIPTION OF EMBODIMENTS

Hereinafter, embodiments of the present disclosure will be described with reference to the drawings. The shapes, materials, numbers, and numerical values described below are examples for explanation and can be appropriately changed in accordance with the specifications of an autonomous vehicle management device and an autonomous vehicle management system. In the following, the same reference numerals are given to equivalent elements in all drawings.

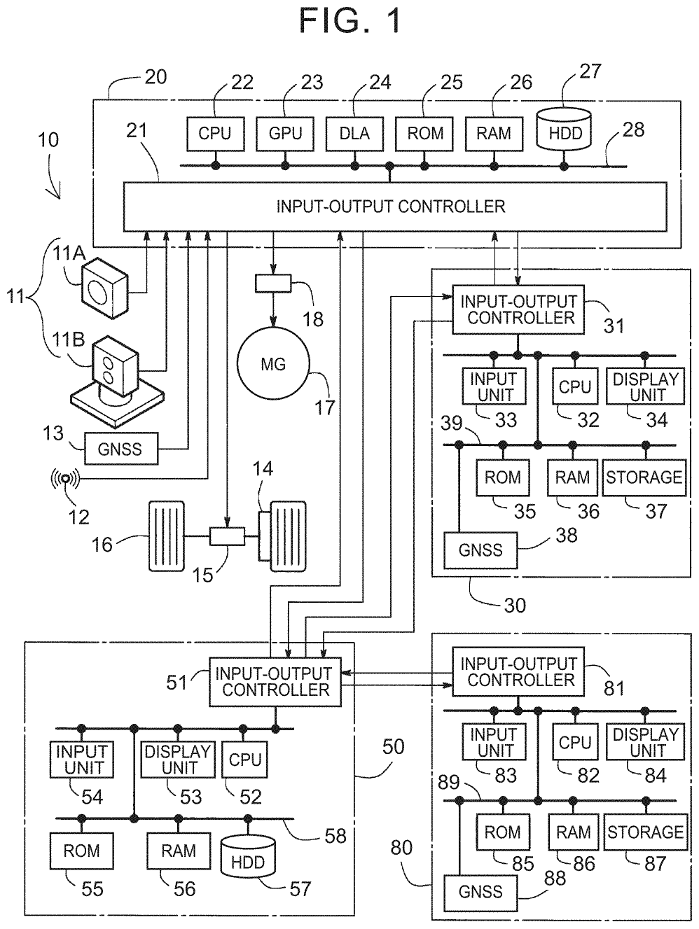

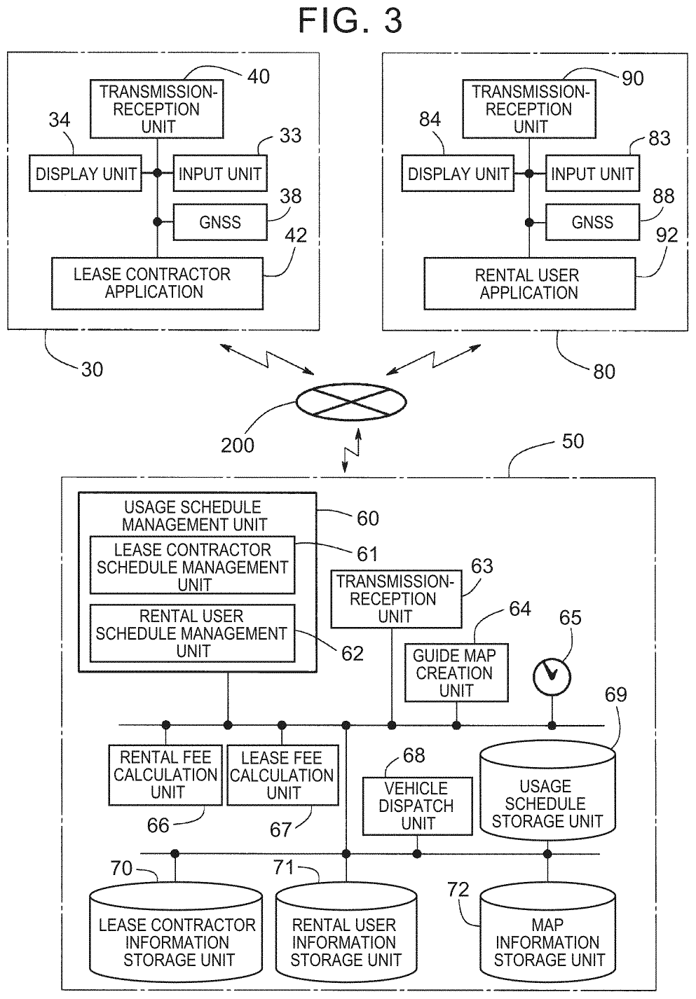

FIG. 1 illustrates the hardware configuration of an autonomous vehicle management system according to the present embodiment, and FIG. 3 illustrates a diagram in which a functional block is included as a part of the system. The autonomous vehicle management system according to the present embodiment includes an autonomous vehicle 10, a lease contractor terminal 30, an autonomous vehicle management device 50, and a rental user terminal 80.

Here, in FIG. 3, in particular, a block necessary for making a usage reservation of the autonomous vehicle 10 by the lease contractor and the rental user is illustrated. For example, when the autonomous vehicle 10 is actually boarded, a destination input function and a map function are implemented in the autonomous vehicle 10, the lease contractor terminal 30, the autonomous vehicle management device 50, and the rental user terminal 80. However, in the following, in order to simplify the illustration and description, the description of implemented functions having little relation to the usage reservation of the autonomous vehicle 10 will be omitted as appropriate.

The autonomous vehicle 10, the lease contractor terminal 30, the autonomous vehicle management device 50, and the rental user terminal 80 can communicate with each other via a communication means such as the Internet 200 (see FIG. 3). The autonomous vehicle 10 can be moved by traveling by autonomous driving, and the lease contractor terminal 30 and the rental user terminal 80 are carried by the lease contractor and the rental user, respectively. For this reason, the autonomous vehicle 10, the lease contractor terminal 30, and the rental user terminal 80 that are mobile bodies can communicate with the autonomous vehicle management device 50 by wireless communication.

Autonomous Vehicle

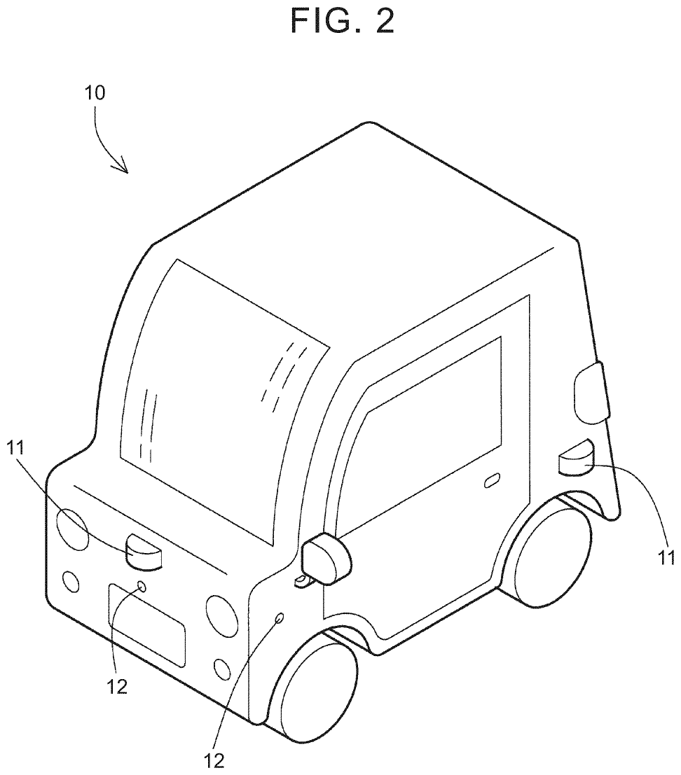

FIG. 2 illustrates the appearance of the autonomous vehicle 10. For example, the autonomous vehicle 10 is also called personal mobility or ultra-small mobility, and is a small vehicle having a capacity of one or two people.

The autonomous vehicle 10 is capable of autonomous driving at level 4 or level 5, for example, among the autonomous driving levels set by the Society of Automotive Engineers (SAE) in USA. Further, a steering device such as a steering wheel may be provided in the vehicle so that a user can manually drive the vehicle while riding the vehicle.

In the autonomous vehicle management system according to the present embodiment, the autonomous vehicle 10 that is a personal mobility is the object of a lease agreement in a lease contract and a rental contract. The lease contract refers to a lease agreement over a relatively long period of time, for example, one year or five years. In contrast, a rental contract refers to a relatively short-term lease agreement on an hourly or daily basis. As will be described later, the autonomous vehicle 10 during a lease contract period is subleased (or rented) to a rental user who is a general user who does not have a lease contract, during a so-called idle period when the lease contractor does not use the vehicle.

Compared to a vehicle that requires to be driven by a driver, since the autonomous vehicle 10 is driven autonomously by itself, uniform driving is possible regardless of the driving skill of an occupant. Thus, a wide range of people who are not confident in driving including elderly people and inexperienced drivers who do not usually drive, can be lease contractors and rental users.

With reference to FIGS. 1 and 2, the autonomous vehicle 10 is an electric vehicle that uses a rotary electric machine 17 (motor) as a drive source and a battery (not shown) as a power source. As described above, since the autonomous vehicle 10 is a small vehicle having a capacity of one or two people, the battery space is limited due to the size of the vehicle, and therefore the cruising range is also limited. Thus, for example, the autonomous vehicle 10 is mainly used as a short-distance transportation means in an urban area.

The autonomous vehicle 10 includes a steering mechanism 15 for steering wheels 16 and a brake mechanism 14 for braking the wheels 16 as traveling control mechanisms. The steering mechanism 15 includes, for example, a tie rod (not shown) for rotating the wheels 16 that are for steering and a steering motor (not shown) capable of moving the tie rod in the vehicle width direction. Further, the brake mechanism 14 includes, for example, a disc brake mechanism (not shown) and a motor pump (not shown) that adjusts a hydraulic pressure of brake oil in the disc brake mechanism (that is, a pressing pressure of a brake pad against the brake disc). Further, the autonomous vehicle 10 includes an inverter 18 that controls the output of the rotary electric machine 17.

Further, the autonomous vehicle 10 is equipped with a mechanism for enabling autonomous driving (also referred to as autonomous driving). Specifically, as a mechanism for enabling autonomous driving, the autonomous vehicle 10 includes a camera 11A, a LiDAR unit 11B, a proximity sensor 12, a positioning unit 13, and a control unit 20.

With reference to FIG. 2, the autonomous vehicle 10 is provided with sensor units 11 on the front surface, the rear surface, and both side surfaces thereof. The sensor unit 11 includes the camera 11A (see FIG. 1) and the LiDAR unit 11B.

The LiDAR unit 11B is a sensor unit for autonomous driving, and uses a lidar (LiDAR, light detection and ranging), that is, a technique for measuring a distance to a peripheral object using a laser beam. The LiDAR unit 11B includes an emitter that irradiates an infrared laser beam toward the outside of the vehicle, a receiver that receives the reflected light, and a motor that rotates the emitter and the receiver.

For example, the emitter irradiates an infrared laser beam toward the outside of the vehicle. When the laser light emitted from the emitter hits an object around the autonomous vehicle 10, the reflected light is received by the receiver. The distance between the reflection point and the receiver is determined based on the time it takes from the irradiation of the emitter to the reception of the receiver. Further, when the emitter and the receiver are rotated by the motor, the laser beam is scanned in the horizontal direction and the vertical direction and thus, three-dimensional point cloud data about the surrounding environment of the autonomous vehicle 10 can be acquired.

Returning to FIG. 1, the camera 11A captures the same field of view as the LiDAR unit 11B. The camera 11A includes an image sensor such as a CMOS sensor or a CCD sensor. The proximity sensor 12 is, for example, an infrared sensor, and is provided on the front surface, the rear surface, and both side surfaces of the vehicle as illustrated in FIG. 2. For example, when the autonomous vehicle 10 arrives at the boarding place, the proximity sensor 12 detects a protrusion such as a curb on a sidewalk. By this detection, it is possible to control the correct arrival of the autonomous vehicle 10 so that it is brought close to the curb and stopped.

The positioning unit 13 is a system for positioning by an artificial satellite, and for example, a global navigation satellite system (GNSS) is used. By using the positioning unit 13, it is possible to estimate a position (latitude and longitude) of the own vehicle with an accuracy within a positioning error range of an artificial satellite.

The control unit 20 may be, for example, an electronic control unit (ECU) of the autonomous vehicle 10, and is composed of a computer (electronic computer). The control unit 20 includes an input-output controller 21 that controls input and output of data as its hardware configuration. Further, the control unit 20 includes a CPU 22, a graphics processing unit (GPU) 23, and deep learning accelerators (DLA) 24 as arithmetic units. The control unit 20 also includes a read-only memory (ROM) 25, a random access memory (RAM) 26, and a hard disk drive (HDD) 27 as storage units. A storage device such as a solid state drive (SSD) may be used instead of the hard disk drive 27. These components are connected to an internal bus 28.

A program for performing autonomous driving control of the autonomous vehicle 10 is stored in at least one of the ROM 25 and the hard disk drive 27 that are storage devices. When the above program is executed by the CPU 22 and the like of the control unit 20, the control unit 20 functions as an autonomous traveling control unit that controls autonomous driving.

For example, the control unit 20 acquires a captured image captured by the camera 11A. Next, the control unit 20 performs image recognition on the acquired captured image using a known deep learning method such as a single shot multibox detector (SSD) or you only look once (YOLO) that use supervised learning. By this image recognition, object detection in the captured image and its attributes (a vehicle, a passerby, a structure, and the like) are recognized.

Further, the control unit 20 acquires the three-dimensional point cloud data from the LiDAR unit 11B and executes clustering to divide the three-dimensional point cloud into a plurality of clusters. Further, the control unit 20 creates peripheral data in which coordinates of the image-recognized captured image and the clustered three-dimensional point cloud data are overlapped. From this peripheral data, it is possible to detect the attribute of an object and detect how far the object is from the autonomous vehicle 10.

Further, the control unit 20 acquires self position information (latitude and longitude) from the positioning unit 13. For example, the control unit 20 acquires the self position information from an artificial satellite. Further, the autonomous vehicle management device 50 transmits guide map data including a latitude-longitude coordinate system to the control unit 20. The control unit 20 controls the traveling of the autonomous vehicle 10 based on the peripheral data including camera images and three-dimensional point cloud data, the guide map data, and the self position information (own vehicle position information).

For example, a global course is determined along the self position and the traveling route included in the guide map data. Furthermore, based on the surrounding data, a local course such as a course avoiding obstacles in front is determined. The control unit 20 controls the brake mechanism 14, the steering mechanism 15, and the inverter 18 according to these paths.

In the leasing service and rental service of the autonomous vehicle 10, for example, it is defined that the vehicle is returned to a predetermined place (for example, a parking lot) at the end of use (at the time of return). Based on such a rule, for example, the autonomous vehicle 10 that has arrived at the destination returns to the departure location (that is, the returning location) along the traveling route by traveling by autonomous driving.

Lease Contractor Terminal

The lease contractor terminal 30 is a communication terminal device owned by a person (lease contractor) who has concluded a leasing contract of the autonomous vehicle 10 with a leasing company or the like having the autonomous vehicle management device 50. The lease contractor terminal 30 may be, for example, a smartphone. FIG. 1 illustrates the hardware configuration of the lease contractor terminal 30. The lease contractor terminal 30 includes an input-output controller 31, a CPU 32, an input unit 33, a display unit 34, and a positioning unit 38. Further, the lease contractor terminal 30 includes a ROM 35, a RAM 36, and a storage device 37 as a storage unit. These components are connected to an internal bus 39.

The input unit 33 and the display unit 34 may be integrally formed as a touch panel. As will be described later, the usage date, the usage start time, and the usage end time can be input to the input unit 33 when a usage reservation (priority usage reservation) of the autonomous vehicle 10 is made.

In addition, the positioning unit 38 can acquire the terminal position that is its current position. For example, similar to the positioning unit 13 of the autonomous vehicle 10, the positioning unit 38 is a system for positioning with an artificial satellite, and for example, a global navigation satellite system (GNSS) is used.

At least one of the ROM 35 and the storage device 37 that are storage devices stores a program for using the usage reservation service of the autonomous vehicle 10. When this program is executed by the CPU 32 or the like of the lease contractor terminal 30, the lease contractor terminal 30 is formed with a functional block as shown in FIG. 3. Further, when the CPU 32 executes the above program stored in a non-transient computer-readable storage medium such as a DVD, a functional block as shown in FIG. 3 is also formed. That is, the lease contractor terminal 30 includes a transmission-reception unit 40 and a lease contractor application 42 as functional blocks.

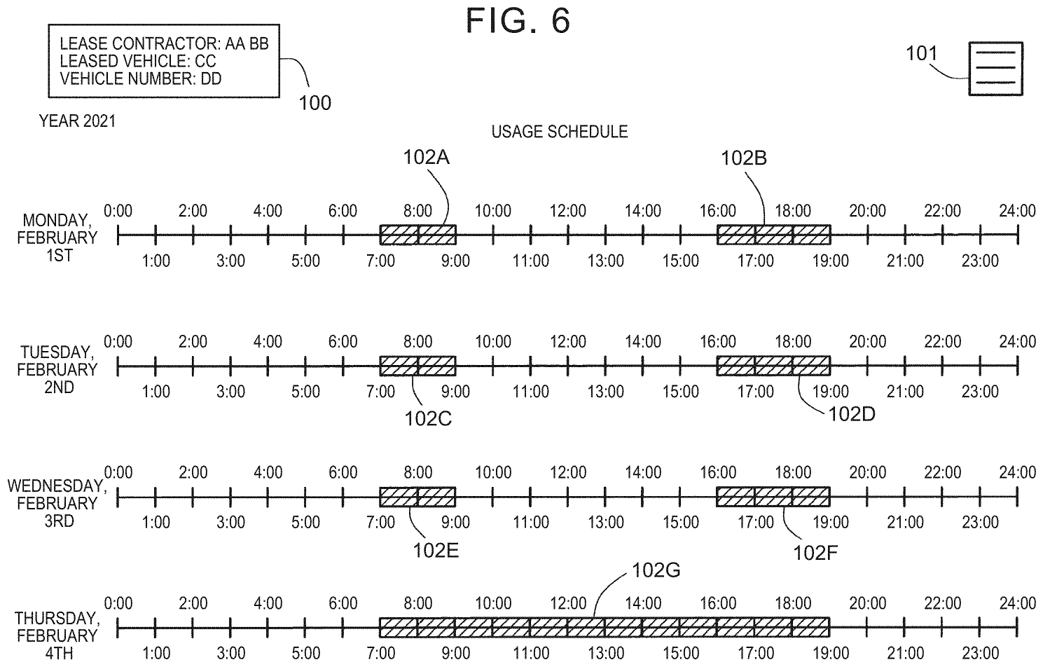

As will be described later, the lease contractor application 42 controls a display image of the display unit 34 and processes the information input from the input unit 33. The lease contractor application 42 causes the display unit 34 (that is a touch panel) to display a usage schedule screen as illustrated in FIGS. 6, 7, 8, 14, 16, and the like. The lease contractor makes a usage reservation of the autonomous vehicle 10 by tap operation an arbitrary area of the usage schedule screen that also serves as the input unit 33.

The lease contractor is a priority user who can preferentially use the autonomous vehicle 10 subject to the lease contract. For example, the time zone in which the lease contractor makes a usage reservation is treated as a priority usage reservation time zone. The usage reservation by the priority user, that is, the priority usage reservation has priority over the usage reservation by a rental user (general user) who is a counterpart of a sublease (lending), that is, a general usage reservation. Specifically, as will be described later, after the general usage reservation time zone is set by the rental user (general user), the lease contractor (priority user) can set a duplicate priority usage reservation in the same time zone. In such a case, the general usage reservation time zone that is set earlier and that overlaps with the priority usage reservation time zone is deleted.

Rental User Terminal

The rental user terminal 80 is a communication terminal device owned by a person who has concluded a rental contract for the autonomous vehicle 10 with a leasing company or the like equipped with the autonomous vehicle management device 50, that is, a rental user. The rental user terminal 80 may be, for example, a smartphone.

FIG. 1 illustrates the hardware configuration of the rental user terminal 80. The rental user terminal 80 includes an input-output controller 81, a CPU 82, an input unit 83, a display unit 84, and a positioning unit 88 in the same manner as the lease contractor terminal 30. The rental user terminal 80 includes a ROM 85, a RAM 86, and a storage device 87 as storage units. These components are connected to an internal bus 89.

The input unit 83 and the display unit 84 may be integrally formed as a touch panel. As will be described later, the rental user can input the usage date, the usage start time, and the usage end time from the input unit 83 when making a usage reservation (general usage reservation) of the autonomous vehicle 10.

In addition, the positioning unit 88 can acquire the terminal position that is its current position. For example, similar to the positioning unit 13 of the autonomous vehicle 10, the positioning unit 88 is a system for positioning with an artificial satellite, and for example, a global navigation satellite system (GNSS) is used.

At least one of the ROM 85 and the storage device 87 that are storage devices stores a program for using the usage reservation service of the autonomous vehicle 10. When this program is executed by the CPU 82 or the like of the rental user terminal 80, the rental user terminal 80 is formed with a functional block as shown in FIG. 3. Further, when the CPU 82 executes the above program stored in a non-transient computer-readable storage medium such as a DVD, a functional block as shown in FIG. 3 is also formed. The rental user terminal 80 includes a transmission-reception unit 90 and a rental user application 92 as functional blocks.

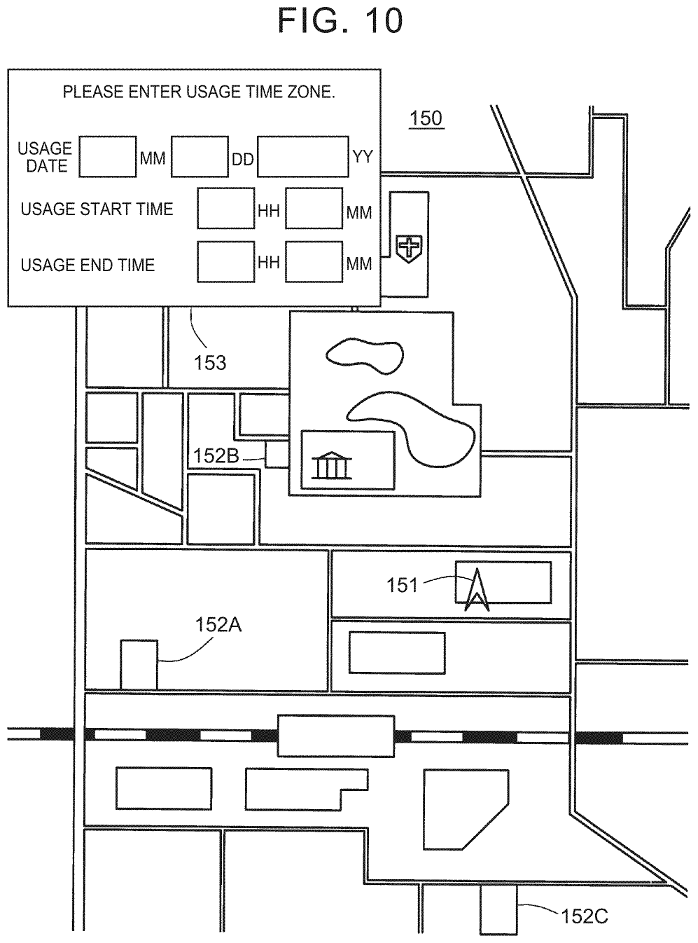

The rental user application 92 controls the display image of the display unit 84 and processes the information input from the input unit 83. As will be described later, the rental user application 92 causes the display unit 84 (that is a touch panel) to display a general usage reservation screen as illustrated in FIGS. 10 to 13, 17, 18, and the like. The rental user makes a usage reservation (general usage reservation) of the autonomous vehicle 10 by tap operation an arbitrary area of the general usage reservation screen that also serves as the input unit 83.

The lease contractor can sublease (or lend) the autonomous vehicle 10 subject to the lease contract to the rental user. Specifically, as will be described later, a general user who is a rental user can set a usage reservation of the autonomous vehicle 10 in a vacant time that does not overlap with the priority usage time zone set by the lease contractor (priority user). The usage reservation time zone set by the rental user is called a general usage time zone.

By subleasing the idle autonomous vehicle 10 to the rental user in this way, the autonomous vehicle 10 can be effectively utilized. Further, for example, the lease contractor receives the rental fee in accordance with the general usage time zone, or the rental fee is deducted from the lease fee, so that the fee burden of the lease contractor is reduced.

Autonomous Vehicle Management Device

The autonomous vehicle management device 50 is installed in, for example, a company that provides a leasing service and a rental service for the autonomous vehicle 10. In the following, the autonomous vehicle management device 50 is also appropriately described as a “vehicle management device 50” that is its abbreviation.

The vehicle management device 50 is composed of, for example, a computer (electronic computer). With reference to FIG. 1, the vehicle management device 50 includes an input-output controller 51, a CPU 52, an input unit 53, and a display unit 54 as its hardware configuration. Further, the vehicle management device 50 includes a ROM 55, a RAM 56, and a hard disk drive (HDD) 57 as storage units. These components are connected to an internal bus 58.

A program for setting and adjusting the usage schedule of the autonomous vehicle 10 is stored in at least one of the ROM 55 and the hard disk drive 57 that are storage devices. When this program is executed by the CPU 52 or the like of the vehicle management device 50, a functional block as shown in FIG. 3 is formed in the vehicle management device 50. Further, when the CPU 52 executes the above program stored in a non-transient computer-readable storage medium such as a DVD, a functional block as shown in FIG. 3 is also formed.

That is, the vehicle management device 50 includes a usage schedule management unit 60, a transmission-reception unit 63, a guide map creation unit 64, a clock 65, a rental fee calculation unit 66, a lease fee calculation unit 67, a vehicle dispatch unit 68, a usage schedule storage unit 69, a lease contractor information storage unit 70, a rental user information storage unit 71, and a map information storage unit 72 as functional blocks.

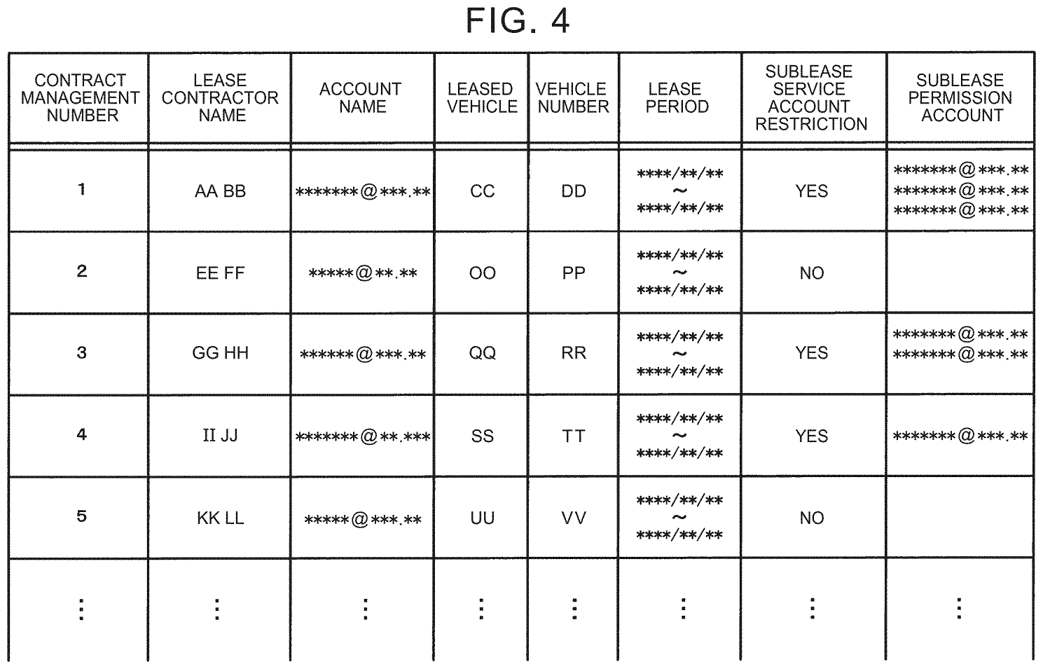

The lease contractor information storage unit 70 is also referred to as a priority user information storage unit. The lease contractor information storage unit 70 (priority user information storage unit) associates identification information given to the predetermined autonomous vehicle 10 with the lease contractor who can preferentially use the vehicle (that is, the priority user) and stores the above. FIG. 4 exemplifies a lease contractor information table stored in the lease contractor information storage unit 70.

The lease contractor information table is provided with a contract management number, a lease contractor name, an account name, leased vehicle information, a vehicle number, a lease period, information of whether there is a sublease service account restriction, and a sublease permission account column. In addition to these items, an address, contact information, and a license number of the lease contractor, a credit card number, a returning location of the autonomous vehicle 10 subject to the leasing contract, a password for logging in to the lease contractor application 42, and the like may be provided.

The account name is, for example, a name (member name) for identifying a lease contractor when using the lease contractor application 42. For example, an email address of the lease contractor is used as the account name. Further, as the leased vehicle information, the vehicle information subject to the lease contract is stored. Vehicle information includes a model number, a model year, mileage, and the like.

In the column of the information of the presence or absence of a sublease service account restriction, the presence or absence of an account restriction is stored. In providing the rental service (or lending service) of the autonomous vehicle 10, when a specific person such as a family member or an employee is permitted to rent the autonomous vehicle 10, the account restriction is set to be valid (YES). Further, in the sublease permission account column, the account of the rental user who permits the autonomous vehicle 10 to be rented is stored.

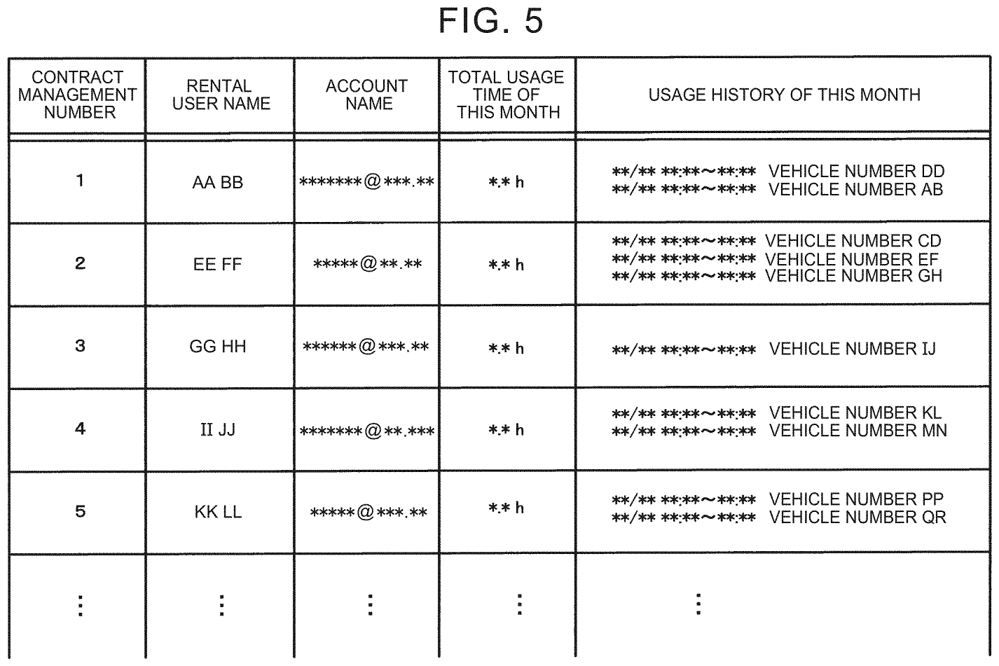

The rental user information storage unit 71 is also called a general user information storage unit. Information related to the rental user is stored in the rental user information storage unit 71 (general user information storage unit). FIG. 5 illustrates a rental user information table stored in the rental user information storage unit 71.

The rental user information table is provided with items such as a contract management number, a rental user name, an account name, a total usage time of the current month, and a usage history of the current month. In addition to these items, items such as the rental user's address, contact information, and license number, a credit card number, and a password for logging in to the rental user application 92 may be provided.

Similar to the lease contractor information table, the account name is a name (member name) for identifying the rental user when using, for example, the rental user application 92. For example, an email address of the rental user is used as the account name.

With reference to FIG. 3, the map information storage unit 72 stores dynamic map data that is map data. The dynamic map is a three-dimensional map, and for example, the position and shape (three-dimensional shape) of the roadway are stored. The three-dimensional shape of the roadway includes, for example, a gradient, a width, and the like. In addition, positions of lanes, pedestrian crossings, stop lines, and the like that are drawn on the roadway are also stored in the dynamic map. In addition, the position and shape (three-dimensional shape) of structures such as buildings and traffic lights around the road are also stored in the dynamic map. Furthermore, the position and shape of the parking lot are also stored in the dynamic map.

For example, a dynamic map uses a geographic coordinate system that includes latitude and longitude. When the autonomous vehicle 10 travels by autonomous driving, dynamic map data including a traveling route connecting a departure location and a destination is transmitted from the map information storage unit 72 to the autonomous vehicle 10.

Further, the dynamic map data is processed by the guide map creation unit 64. As shown in FIG. 10 that will be described later, when the rental user application 92 is started, the guide map creation unit 64 creates a map image 150 that is a plane map image including a terminal position 151 and its surroundings.

With reference to FIG. 3, the lease fee calculation unit 67 calculates the lease fee to be charged to the lease contractor. For example, the lease fee calculation unit 67 calculates the lease fee on a monthly basis. When calculating this lease fee, the lease fee calculation unit 67 acquires, for example, a fee in which an amount corresponding to the usage record of the autonomous vehicle 10 by the rental user is subtracted from a monthly fixed basic fee, and charges the lease contractor the above amount.

The rental fee calculation unit 66 calculates the rental fee to be charged to the rental user. For example, the rental fee calculation unit 66 calculates the rental fee each time rental usage is performed. The rental fee calculation unit 66 acquires, for example, a rental fee in accordance with the time from the usage start time to the usage end time stored in the usage schedule storage unit 69, and promptly charges the rental user for the fee after the rental of the autonomous vehicle 10.

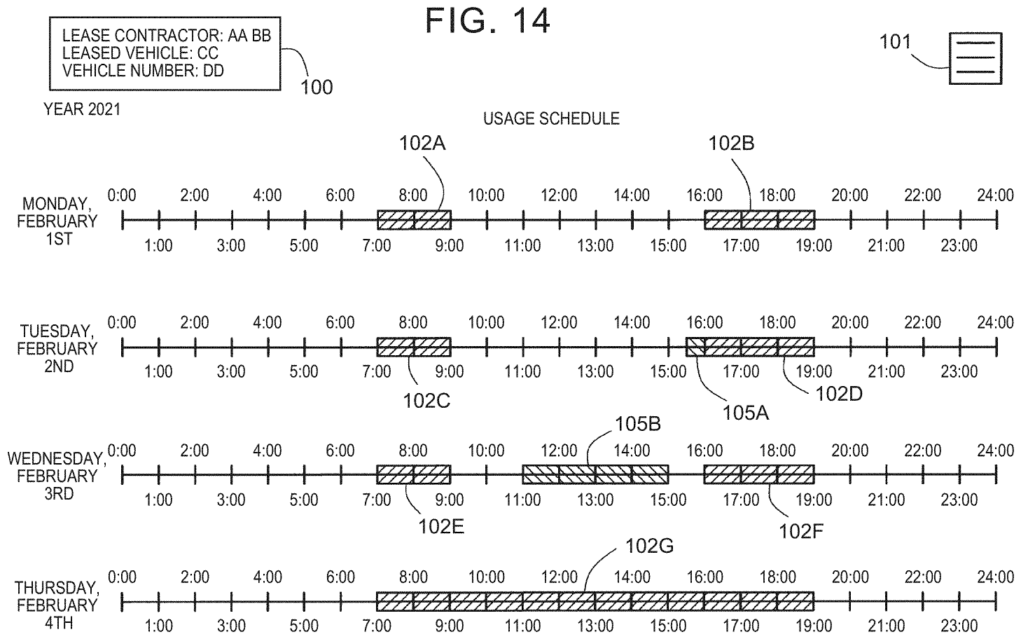

The usage schedule storage unit 69 stores priority usage time zones 102A to 102G and general usage time zones 105A and 105B of the autonomous vehicle 10 as illustrated in FIG. 14, separately for each autonomous vehicle 10. The usage schedule storage unit 69 stores the usage schedules of a plurality of autonomous vehicles 10, separately for each vehicle.

With reference to FIG. 3, the usage schedule management unit 60 includes a lease contractor schedule management unit 61 and a rental user schedule management unit 62. The lease contractor schedule management unit 61 is also referred to as a priority user schedule management unit. The rental user schedule management unit 62 is also called a general user schedule management unit.

The lease contractor schedule management unit 61 (priority user schedule management unit) serves as a contact point on the vehicle management device 50 side when the lease contractor application 42 of the lease contractor terminal 30 is activated. For example, as will be described later, the lease contractor schedule management unit 61 updates the usage schedule after receiving input information received from the lease contractor application 42 via the transmission-reception units 40 and 63. The specific process content will be described later.

The rental user schedule management unit 62 (general user schedule management unit) serves as a contact point on the vehicle management device 50 side when the rental user application 92 of the rental user terminal 80 is activated. For example, as will be described later, the rental user schedule management unit 62 updates the usage schedule after receiving input information received from the rental user application 92 via the transmission-reception units 63 and 90. The specific process content will be described later.

When the general usage time zone and the priority usage time zone overlap, the vehicle dispatch unit 68 makes a vehicle dispatch reservation for the rental user of the autonomous vehicle 10 serving as a substitute vehicle that can be used in this overlapping time zone. The specific content will be described later.

Usage Reservation by Lease Contractor

When the lease contractor (priority user) activates the lease contractor application 42 implemented on the lease contractor terminal 30, an input form (not shown) for entering an account and a password is displayed on the display unit 34. The input account and password information is transmitted to the lease contractor schedule management unit 61 via the transmission-reception units 40 and 63.

The lease contractor schedule management unit 61 (priority user schedule management unit) collates the received account and password information with the respective information stored in the lease contractor information storage unit 70 (priority user information storage unit). When the collation is performed normally, the lease contractor schedule management unit 61 extracts the usage schedule information of the autonomous vehicle 10 associated with the received account from the usage schedule storage unit 69, and transmits the information to the lease contractor terminal 30 via the transmission-reception units 40, 63.

The usage schedule screen illustrated in FIG. 6 is displayed on the display unit 34 of the lease contractor terminal 30. On the usage schedule screen, the name or account of the lease contractor, the leased vehicle information, and an ID box 100 showing the vehicle number are displayed. Further, on the usage schedule screen, a menu button 101 for performing various setting operations is displayed. Further, the usage schedule screen displays the usage schedule of the autonomous vehicle 10 in which a lease contract is made by the lease contractor.

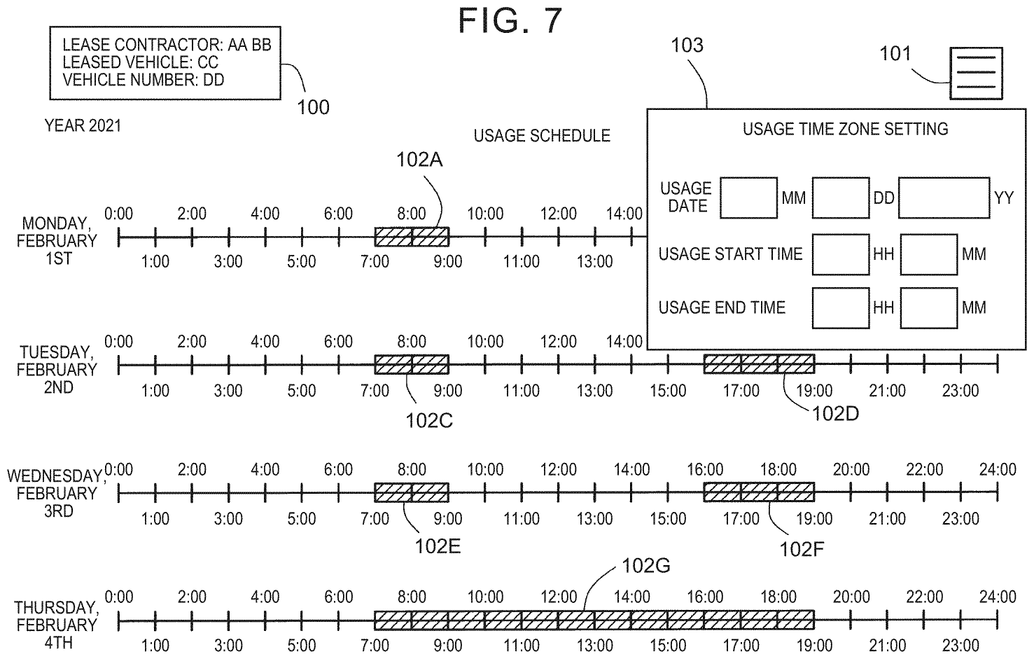

On this usage schedule screen, priority usage time zones 102A to 102G that have already been set are displayed. When an item for setting the usage time (not shown) is selected from the menu button, a schedule setting box 103 is superimposed and displayed on the usage schedule screen, as illustrated in FIG. 7.

In the schedule setting box 103, the usage date, the usage start time, and the usage end time for priority usage by the lease contractor can be input. When these items are input, a priority usage request command including these input information is transmitted from the lease contractor application 42 to the lease contractor schedule management unit 61 via the transmission-reception units 40 and 63.

In accordance with the usage time, the usage start time, and the usage end time included in the priority usage request command, the time zone from the usage start time to the usage end time of the usage date is set in the usage schedule as the priority usage time zone, by the lease contractor schedule management unit 61. The set priority usage time zone information is stored in the usage schedule storage unit 69.

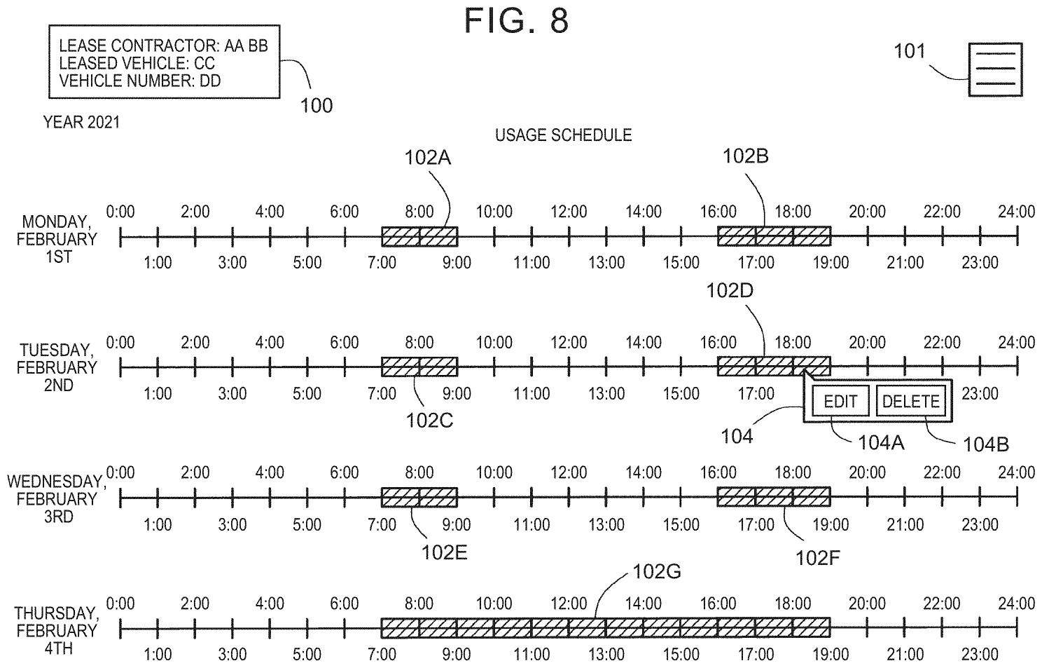

Further, as illustrated in FIG. 8, the lease contractor specifies the set priority usage time zones 102A to 102G (priority usage time zone 102D in FIG. 8) already displayed on the usage schedule screen by tap operation or the like and thus, an edit box 104 is displayed. The edit box 104 includes an edit button 104A and a delete button 104B for the priority usage time zone 102D.

When the lease contractor specifies the edit button 104A by tap operation or the like, the usage start time and usage end time of the already set priority usage time zone 102D can be changed. Further, when the lease contractor specifies the delete button 104B by a tap operation or the like, the already set priority usage time zone 102D can be deleted. These operation information is transmitted to the lease contractor schedule management unit 61 via the transmission-reception units 40 and 63. Further, the lease contractor schedule management unit 61 updates the usage schedule stored in the usage schedule storage unit 69.

Usage Reservation by Rental User

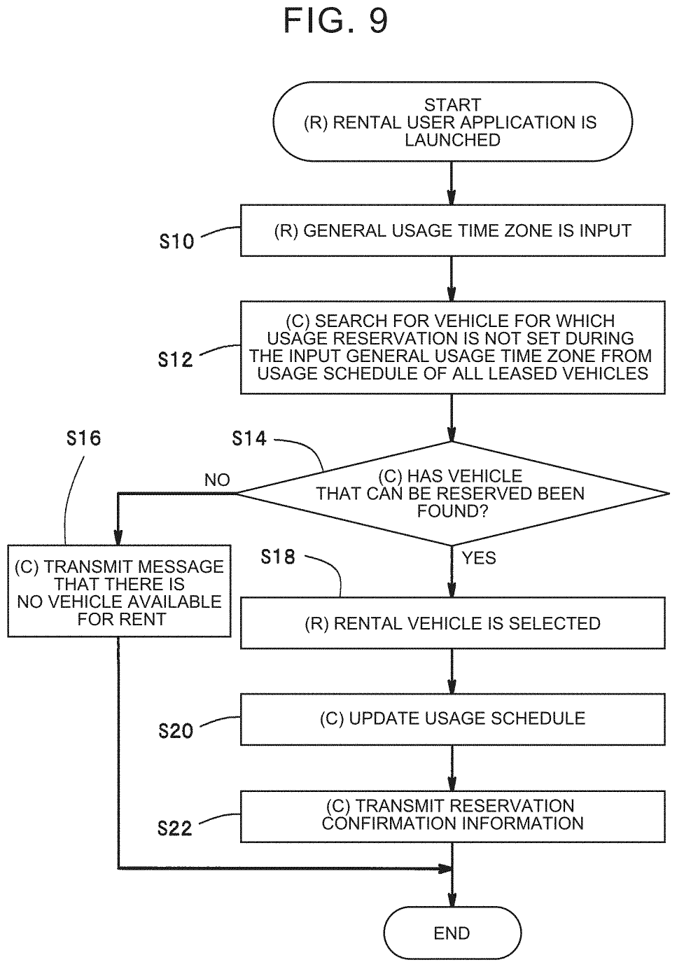

FIGS. 9 to 13 illustrate the process of the rental usage reservation (general usage reservation) of the autonomous vehicle 10 by the rental user, that is, the general user. Note that FIG. 9 illustrates a flowchart of the rental usage reservation, and this flowchart shows the main body of each step. For example, (R) refers to a process by the rental user terminal 80, and (C) refers to a process by the vehicle management device 50.

When the rental user activates the rental user application 92 of the rental user terminal 80, an input form (not shown) for inputting an account and a password is displayed on the display unit 84. The information of the input account and password is transmitted to the rental user schedule management unit 62 (general user schedule management unit) via the transmission-reception unit 63 of the vehicle management device 50.

The rental user schedule management unit 62 collates the received account and password information with the respective information stored in the rental user information storage unit 71. When the collation is normally performed, the rental user schedule management unit 62 acquires the terminal position from the positioning unit 88 of the rental user terminal 80 via the transmission-reception units 63 and 90. Further, as illustrated in FIG. 10, the guide map creation unit 64 creates map image 150 data including the terminal position 151 and transmits it to the rental user application 92 via the transmission-reception units 63 and 90. The rental user application 92 causes the display unit 84 to display the map image 150.

A schedule setting box 153 is displayed on the map image 150. In the schedule setting box 153, the usage date, the usage start time, and the usage end time for usage (general usage) by the rental user can be input. When these items are input (S10 in FIG. 9), these input information are transmitted as a general usage request from the rental user application 92 to the rental user schedule management unit 62 via the transmission-reception units 63 and 90.

The rental user schedule management unit 62 refers to the usage schedule storage unit 69 and searches for a vehicle in which the input general usage time zone is a free time zone, from the usage schedules of all autonomous vehicles 10 stored in the storage unit. In other words, the rental user schedule management unit 62 searches for a vehicle for which a usage reservation has not been set in the time zone from the usage start time to the usage end time input by the rental user (S12).

Further, the rental user schedule management unit 62 determines whether there is the autonomous vehicle 10 capable of being reserved in the input general usage time zone (S14). When the autonomous vehicle 10 capable of being reserved in the general usage time zone input by the rental user is not found, the rental user schedule management unit 62 transmits a message indicating that there is no autonomous vehicle 10 that can be rented to the rental user application 92 via the transmission-reception units 63 and 90 (S16). The message is displayed on the display unit 84.

In contrast, when the autonomous vehicle 10 capable of being reserved in the general usage time zone input by the rental user is found in step S14, the rental user schedule management unit 62 extracts information of the autonomous vehicle 10 that can be reserved. The guide map creation unit 64 refers to the lease contractor information storage unit 70 to acquire the returning location of the autonomous vehicle 10 that can be reserved. The returning location refers to a place where the autonomous vehicle 10 is returned at the end of use, and for example, parking lots 152A to 152C illustrated in FIG. 10 are set.

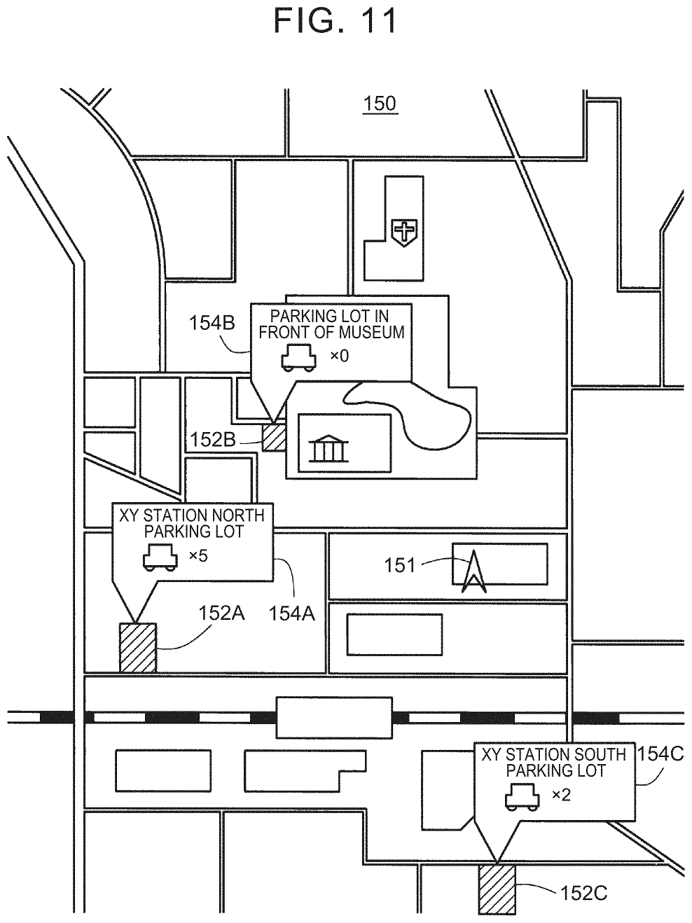

Further, the guide map creation unit 64 transmits the information of the autonomous vehicle 10 that can be reserved to the rental user application 92 via the transmission-reception units 63 and 90 together with the returning location information. As illustrated in FIG. 11, the display unit 84 displays message boxes 154A to 154C indicating the number of autonomous vehicles 10 that can be reserved for each parking lot 152A to 152C.

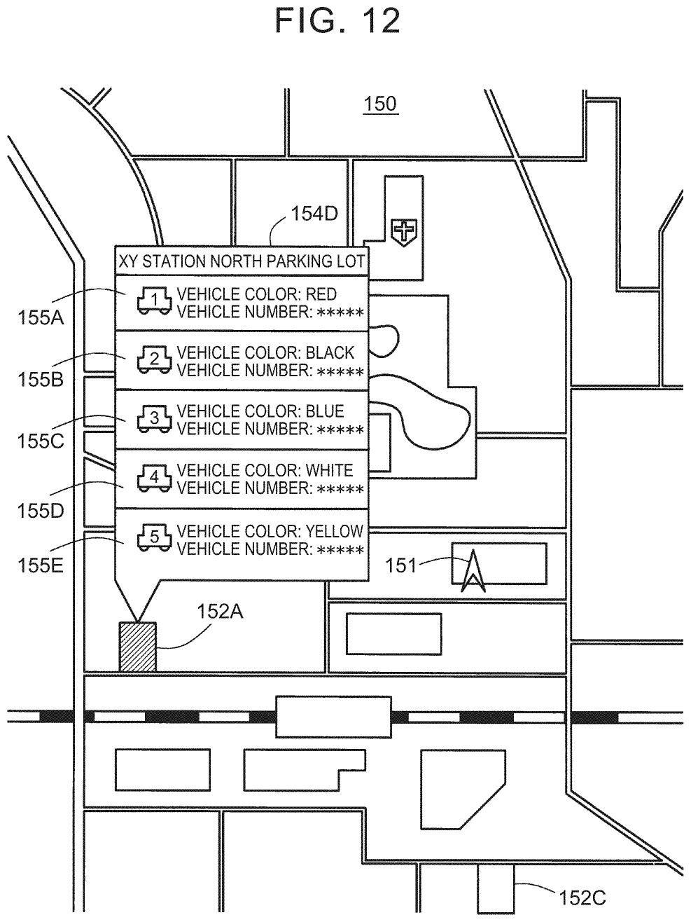

The selection image of the reservable vehicle in FIG. 11 is, so to speak, a selection in a wide area, and when any of the parking lots 152A to 152C is selected by a tap operation of the rental user or the like, the image for narrowing down the options as shown in FIG. 12 is displayed. That is, the rental user application 92 displays a message box 154D showing vehicle information of a reservable vehicle in the selected parking lot (parking lot 152A in FIG. 12) on the map image 150. In this message box 154D, the display area of the vehicle information of the reservable vehicle functions as it is as the selection buttons 155A to 155E.

One of the selection buttons 155A to 155E is selected by a tap operation or the like by the rental user (S18 in FIG. 9). In response to this, vehicle information such as an identification code of the selected autonomous vehicle 10 is transmitted from the rental user application 92 to the rental user schedule management unit 62 via the transmission-reception units 63 and 90.

The rental user schedule management unit 62 updates the usage schedule with reference to the usage schedule storage unit 69 (S20). For example, the rental user schedule management unit 62 sets the time zone input as the general usage request in S10 as the general usage time zones 105A and 105B in the usage schedule, as illustrated in FIG. 14.

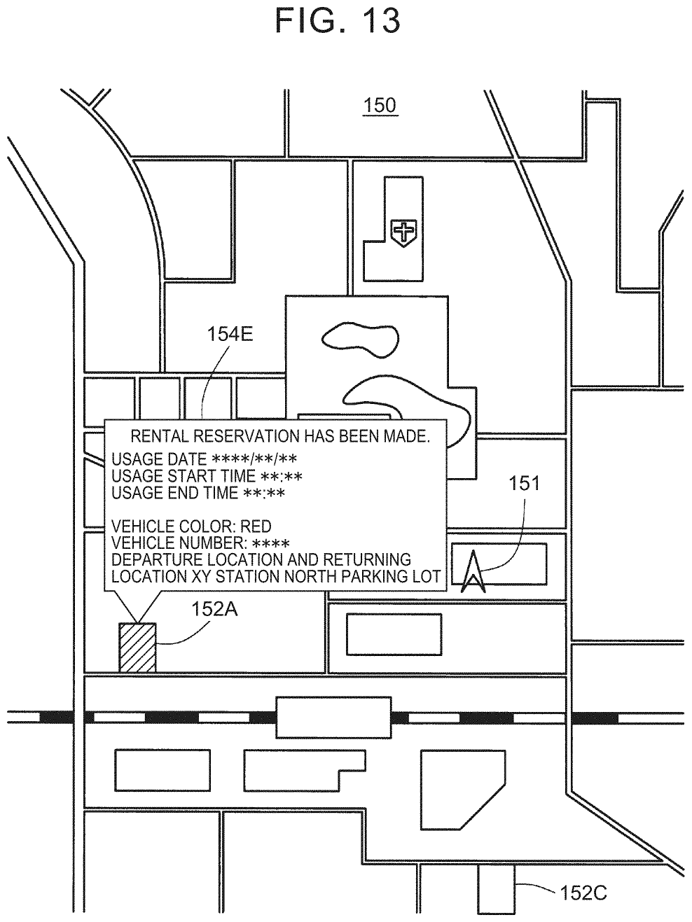

When the usage schedule is updated, the transmission-reception unit 63 transmits the reservation confirmation information to the rental user application 92 via the transmission-reception unit 90 (S22). On the display unit 84, the message box 154E illustrated in FIG. 13 is displayed on the map image 150. In the message box 154E, information of the general usage time zone, vehicle information, and information of the departure location and the returning location that are included in the reservation confirmation information is displayed.

In this way, in the general usage reservation process, a rental user (general user) different from the lease contractor (priority user) sends a usage request (general usage request) regarding the predetermined autonomous vehicle 10 to the rental user schedule management unit 62. Here, as described above, as the general usage time zones 105A and 105B specified by the general usage request, a time zone excluding the priority usage time zones 102A to 102G that are set for the predetermined autonomous vehicle 10 is specified. In other words, in the general usage reservation process, overlapping of the priority usage time zone and the general usage time zone can be avoided.

Process for Double-Booking

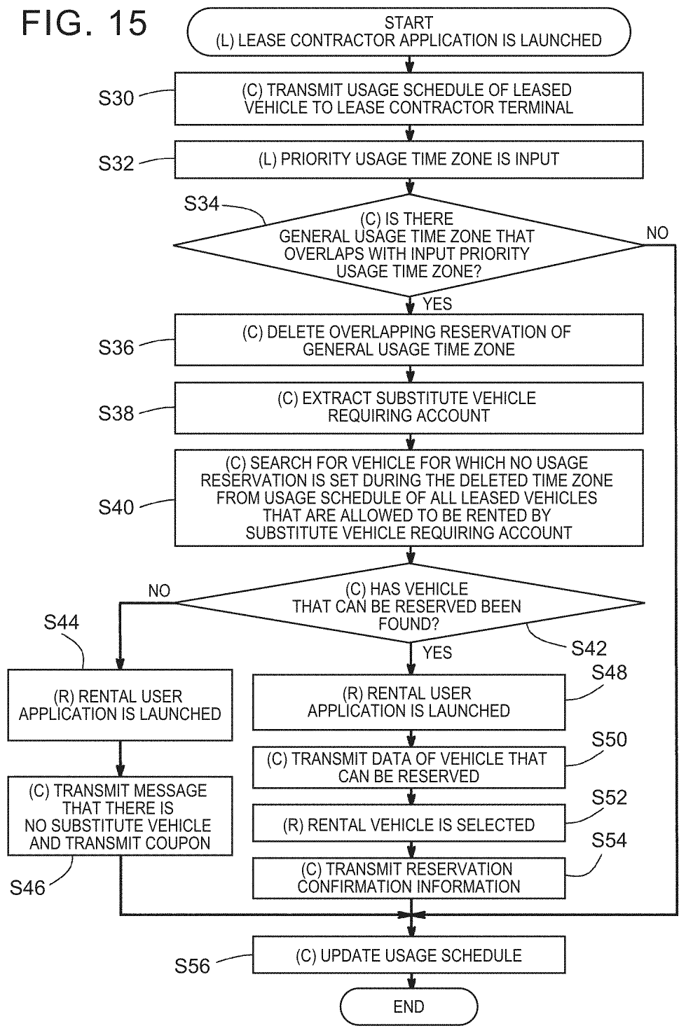

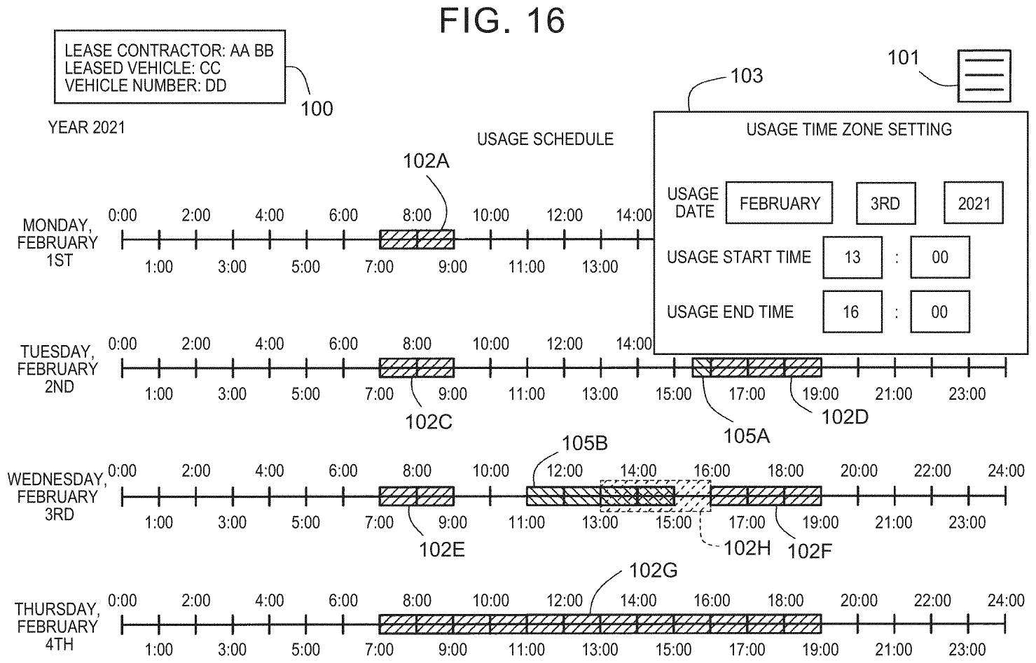

In step S22 of FIG. 9, there is a case in which a priority usage reservation is set after the transmission-reception unit 63 transmits the reservation confirmation information to the rental user application 92. In this case, for example, as shown in FIG. 16, there is a case in which at least a part of a priority usage time zone 102H to be newly set is included in (overlapped with) the already set general usage time zone 105B. A process flow for eliminating such overlap of usage schedules is illustrated in FIG. 15.

As mentioned above, the priority usage by the lease contractor is prioritized over the general usage by the rental user. Therefore, when the already set general usage time zone and the priority usage time zone to be set overlap at least partially, the priority usage time zone set after is prioritized and the general usage time zone set before is cancelled.

In such a case, in order to suppress the deterioration of convenience the general user, the autonomous vehicle management device 50 in accordance with the present embodiment makes a vehicle dispatch reservation of a substitute vehicle. Specifically, as described below, the vehicle dispatch unit 68 of the autonomous vehicle management device 50 searches for another autonomous vehicle 10 in which the canceled general usage time zone is a free time zone and makes the vehicle dispatch reservation for the general user possible with this autonomous vehicle 10 serving as a substitute vehicle.

With reference to FIGS. 3, 15, and 16, the lease contractor (priority user) starts the lease contractor application 42 of the lease contractor terminal 30, and inputs the account and password as described above.

The lease contractor schedule management unit 61 (priority user schedule management unit) collates the received account and password information as described above with the respective information stored in the lease contractor information storage unit 70 (priority user information storage unit). When the collation is performed normally, the lease contractor schedule management unit 61 extracts the usage schedule information of the autonomous vehicle 10 associated with the received account from the usage schedule storage unit 69. Further, the lease contractor schedule management unit 61 transmits the extracted usage schedule information to the lease contractor terminal 30 via the transmission-reception units 40 and 63 (S30).

The usage schedule screen illustrated in FIG. 16 is displayed on the display unit 34 of the lease contractor terminal 30. Further, the lease contractor inputs the usage date, the usage start time, and the usage end time in the schedule setting box 103 (S32). Further, the priority usage request command including the usage date, the usage start time, and the usage end time that are input is transmitted from lease contractor application 42 to the lease contractor schedule management unit 61 (priority user schedule management unit).

Upon receiving the priority usage request command, the lease contractor schedule management unit 61 determines whether there are set general usage time zones 105A and 105B that overlap with the priority usage time zone 102H specified by the usage date, the usage start time, and the usage end time included in the command (S34). If there are no general usage time zones 105A and 105B that overlap with the priority usage time zone 102H, the schedule is updated so that the priority usage time zone 102H is set as it is in the usage schedule (S56).

In contrast, when there are general usage time zones 105A and 105B that overlap with the priority usage time zone 102H (general usage time zone 105B in the example of FIG. 16), the general usage time zone 105B is cancelled. Specifically, the lease contractor schedule management unit 61 causes the rental user schedule management unit 62 (general user schedule management unit) to delete the general usage time zone 105B that overlaps with the priority usage time zone 102H (S36).

In response to this, the vehicle dispatch unit 68 extracts, as the substitute vehicle requiring account, the account of the rental user (general user) who has set the deleted general usage time zone (S38). Further, the vehicle dispatch unit 68 refers to the lease contractor information table (FIG. 4) stored in the lease contractor information storage unit 70, and extracts the autonomous vehicle 10 that permits rental service by a substitute vehicle requiring account.

Here, the autonomous vehicle 10 that allows rental service by the substitute vehicle requiring account includes a vehicle in which the sublease service account restriction is invalidated (set to “NO”). In addition, the vehicle also includes a vehicle in which the sublease service account restriction is enabled (set to “YES”) and in which the sublease permission account includes the substitute vehicle requiring account.

The vehicle dispatch unit 68 searches, as the reservable vehicle, the autonomous vehicle 10 in which the time zone deleted in step S36 is a free time zone, that is, the priority time zone and the general time zone are not set in the deleted time zone, among all autonomous vehicles 10 that allow rental service by the substitute vehicle requiring account (S40).

When the reservable vehicle is not found (S42), the vehicle dispatch unit 68 activates the rental user application 92 of the rental user terminal 80 via the rental user schedule management unit 62 (S44). Then, the vehicle dispatch unit 68 displays a message that the general usage time zone 105B has been canceled and displays a coupon for encouraging future rental usage on the display unit 84 (S46). This coupon may provide, for example, a rental fee discount service.

When returning to step S42 and the reservable vehicle is found, the vehicle dispatch unit 68 activates the rental user application 92 of the rental user terminal 80 via the rental user schedule management unit 62 (S48). In addition, the vehicle dispatch unit 68 transmits the data of the reservable vehicle to the rental user application 92 via the rental user schedule management unit 62 (S50). Reservable vehicle data includes the vehicle's identification code, model number, appearance, and returning location information.

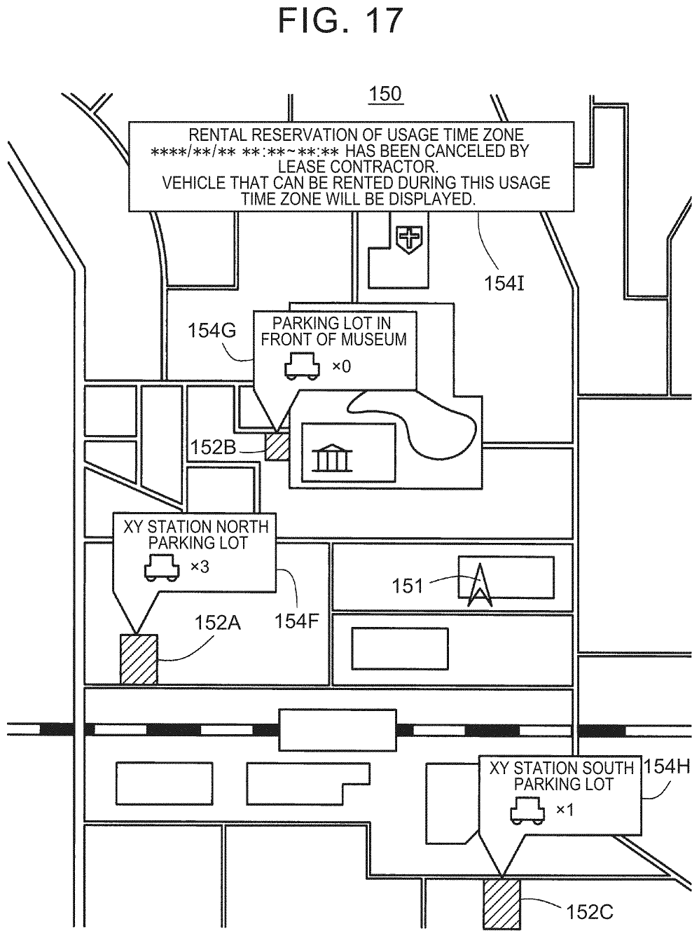

In addition to the reservable vehicle data, the guide map creation unit 64 transmits the map image 150 data around the terminal position 151 to the rental user application 92, as illustrated in FIG. 17. In response to the data, the display unit 84 displays a message box 1541 indicating that the rental reservation has been canceled and the autonomous vehicle 10 that becomes a substitute vehicle, in addition to the map image 150 including the terminal position 151. Further, the display unit 84 displays message boxes 154F to 154H indicating reservable vehicles in the parking lots 152A to 152C.

A rental vehicle is selected from the reservable vehicles by a tap operation or the like by the rental user (S52). In response to this, the rental user application 92 transmits vehicle information such as an identification code of the selected autonomous vehicle 10 to the rental user schedule management unit 62 via the transmission-reception units 63 and 90.

Further, in response to this, the transmission-reception unit 63 transmits the reservation confirmation information to the rental user application 92 via the transmission-reception unit 90 (S54). On the display unit 84, the message box 154E of FIG. 13 described above is displayed on the map image 150. Further, the rental user schedule management unit 62 updates the usage schedule with reference to the usage schedule storage unit 69 (S56).

Restrictions on Double-Booking

In the leasing contract of the autonomous vehicle 10, the lease contractor is prioritized as the priority user over the rental user that is the general user, regarding usage of the autonomous vehicle 10. However, if this prioritized position is excessively protected, this may lead to an excessive disadvantage of the rental user.

For example, when the priority usage time zone is set in the same time zone immediately before the start time of the general usage time zone, the overlapped general usage time zone is deleted. When the start time is immediately before the time the priority usage time zone is set, it becomes difficult to arrange a reservable vehicle that is a substitute vehicle for the canceled rental user (general user) and thus, this may lead to an excessive disadvantage of the rental user.

Therefore, the lease contractor schedule management unit 61 (priority user schedule management unit) may put a restriction that prohibits, for a predetermined period, an input of a priority usage request that specifies a time zone including at least a part of the general usage time zone. Here, the predetermined period may be, for example, a period from a predetermined time before the start time of the general usage time zone to the start time.

For example, taking FIG. 16 as an example, the start time of the general usage time zone 105B is 11:00 on February 3rd. The lease contractor schedule management unit 61 may prohibit an input of the priority usage request that specifies a time zone that at least partially overlaps with the general usage time zone 105B, from 10:00 that is one hour before the start time of 11:00 to 11:00. Then, the lease contractor schedule management unit 61 enables the input prohibition setting when the current time is included in the above period (10:00 to 11:00) with reference to the clock 65 (FIG. 3).

Further, cancellation during rental usage by the priority user may be prohibited by the lease contractor schedule management unit 61. For example, when the current time is included in the general usage time zone, setting a priority usage reservation for the generally used autonomous vehicle 10 may be prohibited by the lease contractor schedule management unit 61.

Movable Range Display

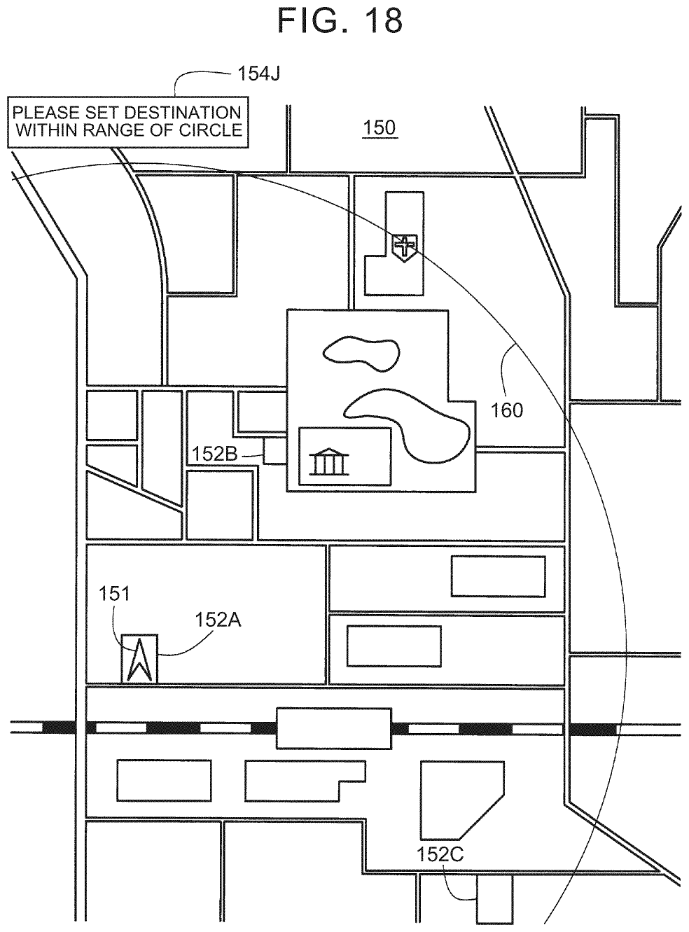

The rental use (general usage) before the start time of the priority usage time zone may be restricted so that the lease contractor (priority user) can surely get on the autonomous vehicle 10 at the start time of the priority usage time zone. For example, referring to FIG. 16, the general usage time zone 105A on February 2nd is provided immediately before the priority usage time zone 102D. Further, the general usage time zone 105A is set for a short period of time, and the travel distance from leaving the parking lot 152A (see FIG. 18) to returning the autonomous vehicle 10 to the parking lot 152A is limited.

Therefore, as illustrated in FIG. 18, the map image 150 showing a movable range 160 of the autonomous vehicle 10 may be displayed in the general usage time zone before the start time of the priority usage time zone.

For example, this movable range 160 is displayed when setting the destination of the autonomous vehicle 10. Further, a message box 154J instructing the destination to be set within the movable range 160 may be displayed in the map image 150. Such a map image 150 is created by the guide map creation unit 64 of the vehicle management device 50 and is displayed on the display unit 84 of the rental user terminal 80. The movable range 160 is set by the rental user schedule management unit 62 in accordance with the set speed of the autonomous vehicle, the traffic congestion in the surrounding area, and the time between the current time and the start time of the priority usage time zone thereafter.

What is claimed is:

1. An autonomous vehicle management device comprising:
a priority user information storage unit that associates identification information given to a predetermined autonomous vehicle with information of a priority user who is able to use the autonomous vehicle with priority and stores the identification information and the information of the priority user;
a priority user schedule management unit that sets a priority usage time zone of the autonomous vehicle in accordance with a priority usage request by the priority user;
a general user schedule management unit that sets a time zone specified by a general usage request as a general usage time zone, when the general user schedule management unit receives, from a general user different from the priority user, the general usage request for the autonomous vehicle in which a time zone other than the priority usage time zone is specified; and
a transmission-reception unit that transmits reservation confirmation information of the general usage time zone to the general user.

2. The autonomous vehicle management device according to claim 1,
wherein after the reservation confirmation information is transmitted, when the general user schedule management unit receives the priority usage request in which a time zone including at least a part of the general usage time zone is specified, the general user schedule management unit cancels a setting of the general usage time zone, and
wherein the autonomous vehicle management device further includes a vehicle dispatch unit that performs, for the general user, a vehicle dispatch reservation of an autonomous vehicle that is able to be used in the canceled general usage time zone and that is different from the autonomous vehicle.

3. The autonomous vehicle management device according to claim 2, wherein the priority user schedule management unit prohibits an input of the priority usage request in which a time zone including at least a part of the general usage time zone is specified, for a period from a predetermined time before a start time of the general usage time zone to the start time.

4. The autonomous vehicle management device according to claim 1, comprising a map creation unit that determines a movable range of the autonomous vehicle used by the general user in accordance with a start time of the priority usage time zone, in the general usage time zone before the start time of the priority usage time zone.
